(19) United States
(12) Patent Application Publication
(10) Pub. No.: US 2009/0217689 A1
(43) Pub. Date: Sep. 3, 2009

(54) INTEGRATED TRANSPORT REFRIGERATION UNIT WITH LIMITED HEAT TRANSFER AND QUICK MOUNT HOUSING

(76) Inventors: Bruno Chakiachvili, Le Neubourg (FR); Joaquim Ferreira, Freneuse (FR); Claude Saudoyez, vieux manoir (FR)

Correspondence Address: CARLSON, GASKEY & OLDS, P.C., 400 WEST MAPLE ROAD, SUITE 350, BIRMINGHAM, MI, 48009, US

(21) Appl. No.: 12/094,412

(22) PCT Filed: Dec. 20, 2005
(86) PCT No.: PCT/US2005/047632

§ 371 Date: Apr. 30, 2009

(51) Int. Cl. B60H 1/32; F25B 1/00; F25D 21/14; B23P 15/26

(52) U.S. Cl. 62/239; 62/498; 62/285; 29/726

(57) ABSTRACT

A refrigeration unit includes an external housing and an internal housing supported by a vehicle roof. The internal housing includes an inner wall spaced from an outer wall with air located between to insulate the components of the refrigeration unit from an interior of a vehicle. The internal housing, a condenser, a compressor, and an evaporator may be assembled together into a refrigeration unit chassis prior to assembly with the vehicle roof. Fasteners are used to assemble the internal housing to the chassis. The external housing and a cover to reduce the amount of contaminants that enter the refrigeration unit. Water drains are located at the bottom of the internal housing along the inner wall to collect and dispose of any water within the refrigeration unit.

### BACKGROUND OF THE INVENTION

The invention relates to a transport refrigeration unit including a condenser located within a vehicle. More particularly, the invention relates to an apparatus and a method for quickly mounting a refrigeration unit to a vehicle and limiting the heat transfer between the refrigeration unit components and the vehicle interior.

Conventional transport refrigeration units provide cooling inside a vehicle compartment. The conventional transport refrigeration units are typically located on a vehicle roof within a refrigeration unit housing. The transport refrigeration unit cools air that is pumped into the vehicle compartment to provide cooling.

A condenser produces heat, and vents within the refrigeration unit housing allow for external airflow to reach the refrigeration unit components to manage the heat created by the condenser during operation. The vehicle roof acts as an insulator to protect the vehicle interior from the heat produced by the condenser.

Locating the refrigeration unit housing on the vehicle roof is unsightly. It would be desirable to locate the refrigeration unit within the vehicle compartment to hide the refrigeration unit components from external view. However, heat from the condenser and other components is emptied into the vehicle compartment, counteracting with the cooled air pumped into the vehicle compartment from the refrigeration unit. Also, moisture from the external environment and water that collects on the evaporator must be disposed of so that is will not leak from the refrigeration unit into the vehicle. Additionally, the refrigeration unit housing must be removable for maintenance and repair.

An arrangement and a method for locating refrigeration unit components in a vehicle while providing a removable housing and sealing from the vehicle interior is needed.

### SUMMARY OF THE INVENTION

In the present invention, a vehicle roof supports a refrigeration unit. The refrigeration unit includes an external housing located primarily outside of the vehicle compartment and an internal housing located primarily inside of a vehicle compartment. The internal housing may have an inner wall spaced from an outer wall with air located between the walls to insulate the components of the refrigeration unit from the interior of the vehicle.

The external housing, a fan, and a fan cover may be assembled prior to assembly on the vehicle roof. Likewise, the internal housing, a condenser, a compressor, and an evaporator may be assembled together into a refrigeration unit chassis prior to assembly with the vehicle roof. Fasteners are used to assemble the internal housing to the chassis for easy removal. The fasteners have a locking portion which is inserted through a hole in the internal housing.

The external housing and the fan cover reduce the amount of water and other external contaminants that enter the refrigeration unit. A gasket may be located between the refrigeration unit and the vehicle roof for further sealing. Water drains are located at the bottom of the internal housing along the inner wall to collect any water within the refrigeration unit. The water drains lead to a water outlet that allows moisture from within the refrigeration unit to drain.

These and other features of the present invention can be best understood from the following specification and drawings, the following of which is a brief description.

### BRIEF DESCRIPTION OF THE DRAWINGS

FIG. 1 is a schematic view of a vapor compression system of the present invention;

FIG. 2 shows a perspective view of a refrigeration unit of the present invention;

FIG. 3 illustrates a schematic side view from within the refrigeration unit; and

FIG. 4 is an exploded view of the components of the refrigeration unit.

FIG. 5a is a cross section of one embodiment of a fastener retaining an internal housing to a chassis of the present invention.

FIG. 5b is a bottom view of one embodiment of the internal housing of the refrigeration unit.

### DETAILED DESCRIPTION OF THE PREFERRED EMBODIMENT

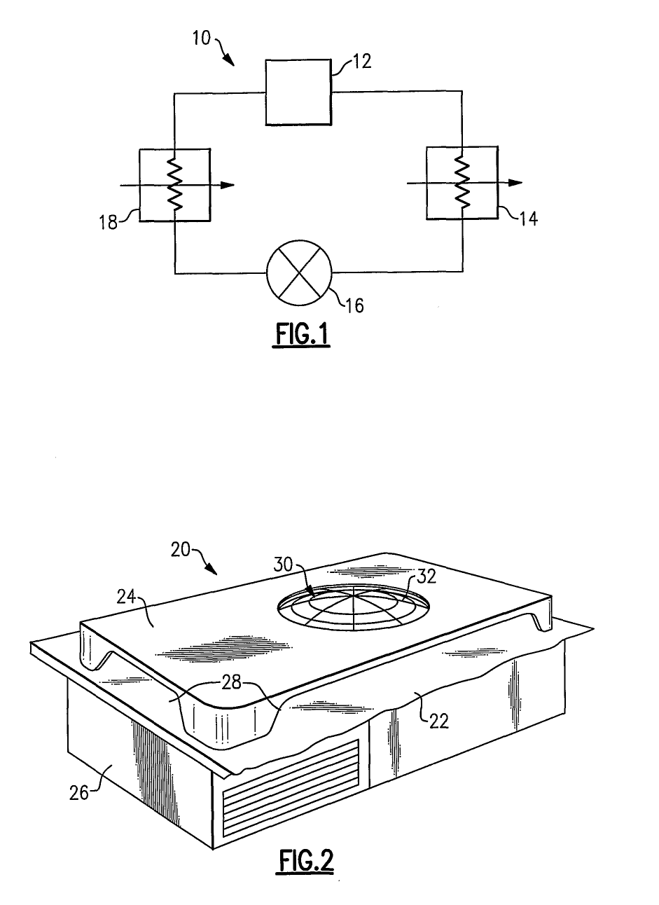

FIG. 1 illustrates a vapor compression system 10, such as a refrigeration system, including a compressor 12 that compresses a fluid, such as refrigerant. From the compressor 12, the refrigerant is delivered downstream to a heat exchanger, such as a condenser 14. In the condenser 14, the refrigerant rejects heat to an external fluid medium. In the embodiment shown, the external fluid medium is air. From the condenser 14, the refrigerant travels to an expansion device 16 and is expanded to a low pressure. The refrigerant accepts heat from another fluid medium, such as air, in an evaporator 18 and then flows to the compressor 12, completing the cycle.

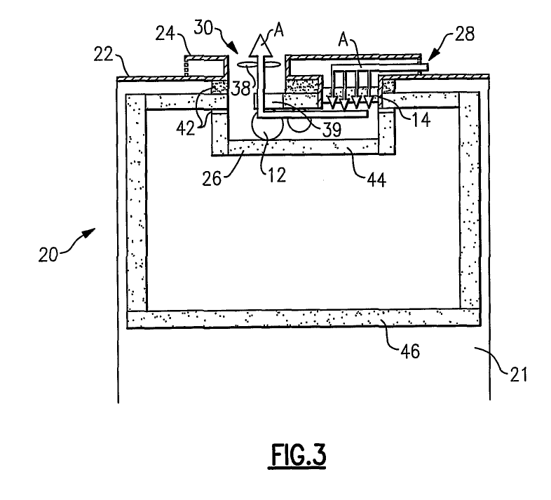

FIG. 2 shows a perspective view of a refrigeration unit 20 of the present invention including the vapor compression system 10. A vehicle roof 22 supports the refrigeration unit 20. The refrigeration unit 20 includes an external housing 24 and an internal housing 26. The external housing 24 is located primarily outside of the vehicle roof 22. The internal housing 26 is located primarily inside of a vehicle compartment 21 and under the vehicle roof 22, as shown. External air enters the external housing 24 through a first opening 28 located between the vehicle roof 22 and the external housing 24. As shown, the refrigeration unit 20 can include multiple first openings 28 to increase the airflow into the refrigeration unit 20. The air passes over the components of the refrigeration unit 20, such as the condenser 14 and the compressor 12 and is heated. The now heated air exits through a second opening 30 in the external housing 24. A cover 32 may be located at the second opening 30 to reduce the amount of water and other external contaminants that may enter the refrigeration unit 20 through the second opening 30. Additionally, the external housing 24 also assists in preventing water and other external contaminants from entering the refrigeration unit 20.

FIG. 3 illustrates a schematic side view of the refrigeration unit 20. External air, illustrated by arrows A, enters the refrigeration unit 20 through the first opening 28. The external air flows past the components of the refrigeration unit 20. Specifically, the air accepts heat from the refrigerant in the condenser 14 and passes over the compressor 12 prior to exiting the refrigeration unit 20 through the second opening 30. The refrigerant cooled by the condenser 14 is expanded in the expansion device 16 and flows into an evaporator 18, where the refrigerant cools air to be sent into the vehicle compartment 21. The outside air accepts heat from both the condenser 14 and the compressor 12, removing heat from the compressor 12 as a result of operation. The heated air exits the refrigeration unit 20 through the second opening 30 and flows outside the vehicle.

A fan 38 located proximate to the second opening 30 controls the airflow through the refrigeration unit 20. A sensor 39 located within the refrigeration unit 20 measures the pressure and activates the fan 38 accordingly. As the sensor 39 senses a rise in the pressure of the air exiting the refrigeration unit 20 above a threshold, the fan 38 is activated. Likewise, when the sensor 39 senses a drop in the pressure of the air exiting the refrigeration unit 20 below a threshold, the fan 38 is deactivated. The cover 32 is attached to the external housing 24 proximate to the second opening 30 to cover the fan 38.

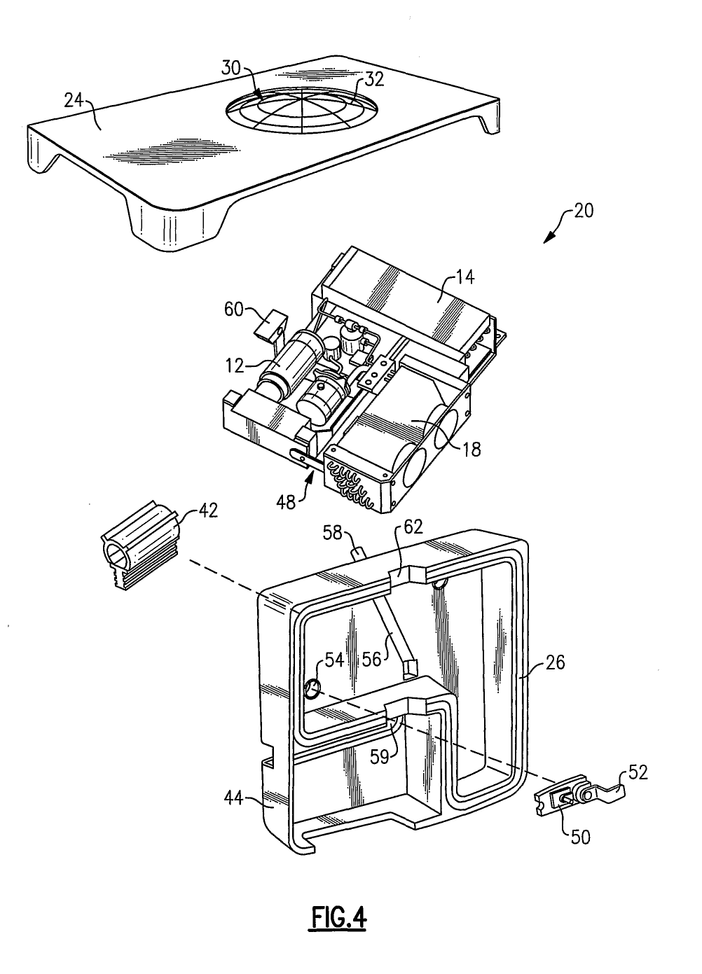

The condenser 14 is located proximate to the first opening 28 and in the airflow path of the refrigeration unit 20. Both the condenser 14 and the compressor 12 are primarily located within the internal housing 26 under the vehicle roof 22. Additionally, the evaporator 18 may also be located within the internal housing 26, as shown in FIG. 4. However, the evaporator 18 need not be located within the airflow path through the refrigeration unit 20.

The internal housing 26 may have a inner wall 44 spaced from an outer wall 46. The inner wall 44, the outer wall 46 and the air located there between insulate the components of the refrigeration unit 20 from the interior of the vehicle. Additionally, a gasket 42 may be located between the refrigeration unit 20 and the vehicle roof 22 for further sealing between the refrigeration unit 20 and the vehicle compartment 21. The gasket 42 may be integrated into grooves in the internal housing 26.

Referring to FIG. 4, the external housing 24, the fan 38, and the cover 32 may be assembled prior to assembly on the vehicle roof 22. The fan 38 is assembled within the second opening 30 in the external housing 24. The cover 32 attaches to the external housing 24 to shield the second opening 30 and fan 38. Likewise, the condenser 14, the compressor 12, and the evaporator 18 may be assembled together into a refrigeration unit chassis 48 prior to assembly with the vehicle roof 22. Fasteners 50 are used to assemble the internal housing 26 to the chassis 48 for easy removal. By pre-assembling the components and providing fasteners 50, handling and removal is facilitated if any maintenance is required.

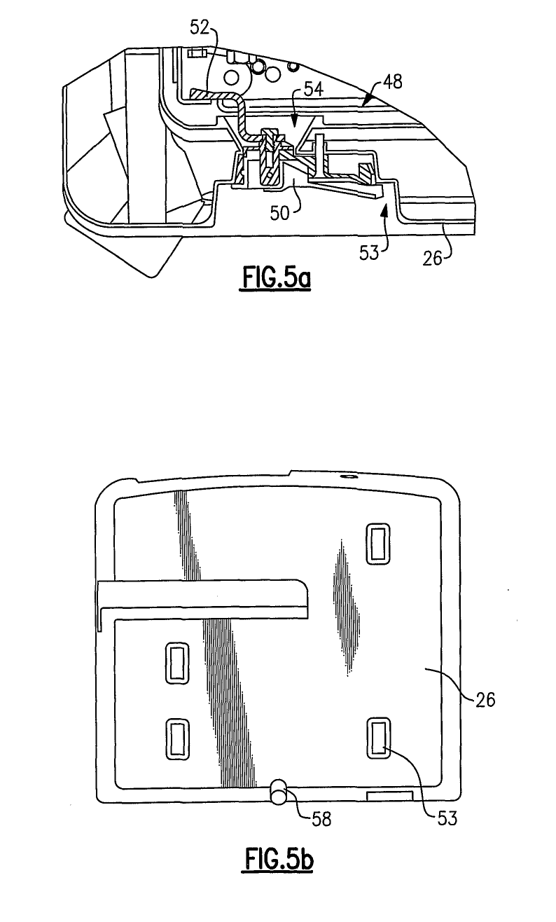

FIG. 5a and 5b illustrate the fasteners 50, which are quarter-turn locking fasteners, and have a locking portion 52 that is inserted through a hole 54 in the internal housing 26. The locking portion 52 engages the chassis 48 to retain the internal housing 26 to the chassis 48. The internal housing 26 has a recessed portion 53 to receive the fasteners 50 on the opposing side of the internal housing 26 that is seen by the vehicle compartment 21. The fasteners 50 provide their own sealing on the locking portion 52 to eliminate any leaking from the refrigeration unit 20 to the vehicle compartment 21 through the insert holes 54 for the locking portion 52. The locking portion 52 may be manufactured from a polyurethane material, or have a sealed disc manufactured from polyurethane material attached. In the embodiment shown, there are four fasteners 50. Additionally, the interior wall 44 of the internal housing 26 may be coated in polyurethane material to aid in sealing. Other types of fasteners or locking devices may also be used. One skilled in the art would know the number and type of fasteners 50 to utilize in a specific application of the invention.

Referring back to FIG. 4, the cover 32 and the external housing 24 also assist in preventing water and other external contaminants from entering the refrigeration unit 20. However, some moisture may still enter the refrigeration unit 20. Also, moisture may collect on the components of the refrigeration unit 20 during operation. Water drains 56 are located at the bottom of the internal housing 26 within the inner wall 44. In the embodiment shown, the water drains 56 are trenches formed in the internal housing 26. Additionally, a drain receiver 59 may be located in the portion of the internal housing 26 that houses the evaporator 18. The water drains 56 and drain receiver 59 may be lined with Mylar foil to limit air bypassing out of the internal housing 26. The water drains 56 and drain receiver 59 lead to a water outlet 58. The water outlet 58 allows moisture from within the refrigeration unit 20 to drain out. The water outlet 58 preferably leads to piping, such as polyvinyl chloride (PVC) pipes, leading to the vehicle exterior. In one embodiment, the water outlet 58 is a 40-millimeter pipe.

Brackets 60 may be manufactured from or coated in a polyurethane material and fixed to the chassis 48. The brackets 60 may fit within inserts 62 in the internal housing 26 to allow any tubing and packaging to reach the refrigeration unit 20. Additionally, the brackets 60 assist in insulating the high-pressure side of internal housing 26 including the compressor 12 and the condenser 14 from the bottom pressure side of the internal housing 26 where the evaporator 18 is located. The brackets 60 also insulate the high-pressure side of the internal housing 26 from the vehicle compartment 21 when the unit is assembled.

The external housing 24, the fan 38, and the cover 32 are assembled together and mounted to the exterior side of the vehicle compartment 21. The compressor 12, the condenser 14, and the evaporator 18 are assembled into the chassis 48. The chassis 48 is then mounted to the interior side of the vehicle compartment 21 to align with the external housing 24 mounted on the exterior side. Drainage pipes are attached to the water outlet 58, and the gasket 42 is assembled onto the internal housing 26. The internal housing 26 is then attached to the chassis 48 using the fasteners 50.

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. A refrigeration unit for a vehicle comprising:
an external housing located primarily outside a vehicle compartment;
an internal housing located primarily inside of said vehicle compartment;
a chassis mounted to an interior surface of said vehicle compartment; and
a plurality of fasteners for removably attaching said chassis to said internal housing.

2. The refrigeration unit of claim 1, wherein said plurality of fasteners are quarter-turn locking fasteners.

3. The refrigeration unit of claim 1, further including a condenser, a compressor, and an evaporator mounted on said chassis.

4. The refrigeration unit of claim 1, wherein said internal housing further includes a water drain.

5. The refrigeration unit of claim 4, wherein said water drain leads to a vehicle exterior.

6. The refrigeration unit of claim 4, wherein said water drain is a trench formed in an inner wall of said internal housing.

7. The refrigeration unit of claim 1, wherein said internal housing includes an inner wall spaced from an outer wall to provide insulation for said refrigeration unit.

8. The refrigeration unit of claim 1, further including a gasket located between said internal housing and said vehicle compartment to provide sealing.

9. A refrigeration unit comprising:
an external housing located primarily outside a vehicle compartment; and
an internal housing located primarily inside said vehicle compartment and including an inner wall and an outer wall, wherein said inner wall is spaced from said outer wall to provide insulation for said refrigeration unit.

10. The refrigeration unit of claim 9, further including a gasket located between said internal housing and said vehicle compartment to provide sealing.

11. The refrigeration unit of claim 9, further including a plurality fasteners associated with said inner wall for removably attaching said internal housing to a chassis that holds a compressor, a condenser and an evaporator.

12. The refrigeration unit of claim 11, further including a plurality of openings located in said inner wall, wherein each of said fasteners are inserted through one of said plurality of openings.

13. The refrigeration unit of claim 11, wherein said plurality of fasteners are quarter-turn locking fasteners.

14. The refrigeration unit of claim 9, further including a water drain is located in said inner wall of said internal housing.

15. The refrigeration unit of claim 14, wherein said water drain leads to the vehicle exterior.

16. The refrigeration unit of claim 14, wherein said water drain is a trench formed in said inner wall of said internal housing.

17. A method of assembling a refrigeration unit comprising:
mounting an external housing outside a vehicle compartment;
assembling a condenser, a compressor, and an evaporator to a chassis;
mounting the chassis to an interior surface of the vehicle compartment; and
attaching an internal housing to the chassis with a plurality of fasteners inside the vehicle compartment.

18. The method of claim 17, wherein said step of attaching the internal housing includes inserting each of the plurality of fasteners through one of a plurality of openings in the internal housing.

19. The method of claim 18, wherein said step of attaching the internal housing includes removably locking the plurality of fasteners to the chassis.

20. The method of claim 17, further including a step of placing a gasket between the vehicle compartment and the internal housing.
